(19) United States
(12) Patent Application Publication
(10) Pub. No.: US 2022/0332595 A1
(43) Pub. Date: Oct. 20, 2022

(54) LOW-TEMPERATURE SYNTHESIS OF HIGH-PURITY AFX ZEOLITE

(71) Applicant: IFP Energies nouvelles, Rueil-Malmaison (FR)

(72) Inventors: Bogdan HARBUZARU, RUEIL-MALMAISON CEDEX (FR); David BERTHOUT, RUEIL-MALMAISON CEDEX (FR); Eric LLIDO, RUEIL-MALMAISON CEDEX (FR); Laetitia JOTHIE, RUEIL-MALMAISON CEDEX (FR); Raquel MARTINEZ FRANCO, RUEIL-MALMAISON CEDEX (FR)

(21) Appl. No.: 17/764,224

(22) PCT Filed: Sep. 18, 2020
(86) PCT No.: PCT/EP2020/076094

§ 371 Date: Mar. 28, 2022

(30) Foreign Application Priority Data
Sep. 30, 2019 (FR) FR1910841

(51) Int. Cl. C01B 39/48

(52) U.S. Cl. CPC C01B 39/48; C01P 2002/72; C01P 2006/80

(57) ABSTRACT

The invention relates to a process for synthesizing a high-purity AFX zeolite, comprising at least the following steps:

i) mixing, in an aqueous medium, of at least one source of silicon (Si) in SiO₂ oxide form, at least one source of aluminum (Al) in Al₂O₃ oxide form, a nitrogenous organic compound of 1,6-bis(methylpiperidinium)hexane dihydroxide type, and at least one source of at least one alkali metal chosen from lithium, potassium or sodium, and the mixture of at least two of these metals, until a homogeneous precursor gel is obtained;
ii) hydrothermal treatment of said precursor gel obtained at the end of step i) at a temperature of between 75° C. and 95° C., limits included, for a period of between 40 and 100 hours, limits included, to obtain a solid AFX-structure crystalline phase, termed “AFX zeolite”. The invention also relates to the high-purity AFX zeolite obtained.

### TECHNICAL FIELD

A subject of the invention is a process for the low-temperature synthesis of an AFX-structure zeolite. In particular, said new process makes it possible to carry out the low-temperature synthesis of a high-purity AFX-structure zeolite, from at least one source of silicon, from at least one source of aluminum, from at least one source of at least one alkali metal and/or alkaline-earth metal of valence n and from a specific organic or structuring molecule comprising two quaternary ammonium functions, 1,6-bis(methylpiperidinium)hexane in dihydroxide form. Said AFX-structure zeolite obtained according to the process of the invention advantageously finds its application as a catalyst, adsorbent or separating agent.

### PRIOR ART

Crystalline microporous materials, such as zeolites or silicoaluminophosphates, are solids that are extensively used in the petroleum industry as catalysts, catalyst supports, adsorbents or separating agents. Although many microporous crystalline structures have been discovered, the refining and petrochemical industry is constantly in search of novel zeolitic structures which have particular properties for applications such as the purification or separation of gases, the conversion of carbon-based species or the like.

AFX-structure zeolites comprise in particular the zeolite SSZ-16 and the zeotypes SAPO-56 and MEAPSO-56. AFX-structure zeolites have a three-dimensional system of pores delimited by eight tetrahedrons and are formed by two types of cages: gmelinite (GME cage) and a large AFT cage (˜8.3×13.0 Å). Numerous methods for synthesizing AFX-structure zeolites, and in particular the zeolite SSZ-16, are known. The SSZ-16 zeolite was synthesized using nitrogenous organic species derived from 1,4-di(1-azoniabicyclo[2.2.2]octane)butyl dibromide type and with a crystallization time typically greater than 3 days and at a temperature greater than or equal to 140° C. (U.S. Pat. No. 4,508,837). Chevron Research and Technology Company prepared SSZ-16 zeolite in the presence of DABCO-Cₙ-diquat cations, where DABCO represents 1,4-diazabicyclo[2.2.2]octane and n is 3, 4 or 5 with a crystallization time typically greater than 3 days and at a temperature greater than 100° C., preferably greater than 130° C. (U.S. Pat. No. 5,194,235). S. B. Hong et al. used the diquaternary alkylammonium ion Et6-diquat-n, where Et6-diquat represents N′,N′-bis-triethylpentanediammonium and n is 5, as a structuring agent for the synthesis of the SSZ-16 zeolite with a formation time of the SSZ-16 zeolite of between 7 and 14 days and at a temperature of 160° C. (Micropor. Mesopor. Mat., 60 (2003) 237-249). Mention may also be made of the use of 1,3-bis(adamantyl)imidazolium cations as a structuring agent for the preparation of AFX-structure zeolite with a crystallization time of between 7 and 10 days and generally of between 2 and 15 days, and at a temperature greater than 100° C., preferably between 120 and 160° C. (R. H. Archer et al., Microp. Mesopor. Mat., 130 (2010) 255-265, Johnson Matthey Company WO2016077667A1). Inagaki Satoshi et al. (JP2016169139A) used divalent N,N,N′,N′-tetraarquirubicyclo[2.2.2]oct-7-ene-2,3:05,6-dipyrrolidium cations substituted with alkyl groups with a crystallization time generally of between 20 and 400 hours and at temperatures between 100 and 200° C., preferably between 150 and 175° C., to prepare the SSZ-16 zeolite. Chevron U.S.A. (WO2017/200607 A1) proposes to carry out the synthesis of an SSZ-16 zeolite with a crystallization time of from 1 to 28 days and at temperatures of between 130 and 175° C. using the dications: 1,1′-(1,4-cyclohexylenedimethylene)bis[1-methylpiperidinium], 1,1′-(1,4-cyclohexylenedimethylene)bis[1-methylpyrrolidinium], cyclohexylenedimethylene)bis[1-ethylpyrrolidinium]. H.-Y. Chen et al. (Johnson Matthey Company, US2018/0093897) used a mixture of cations containing at least 1,3-bis(adamantyl)imidazolium and a neutral amine to prepare the AFX-structure JMZ-10 zeolite in the absence of alkali metal cations with a crystallization time between 1 and 20 days and at temperatures between 100 and 200° C. H-Y. Chen et al. (Johnson Matthey Company, US2018/0093259) used a mixture of cations containing an organic molecule chosen from 1,3-bis(adamantyl)imidazolium, N,N-dimethyl-3,5-dimethylpiperidinium, N,N-diethyl-cis-2,6-dimethylpiperidinium, N,N,N-1-trimethyladamantylammonium, N,N,N-dimethylethylcyclohexylammonium and at least one alkaline-earth metal cation to obtain the AFX-structure JMZ-7 zeolite which has Al sites that are close compared to a zeolite obtained by a synthesis using alkali metal cations. The time required to obtain this zeolite ranges from 3 to 15 days at a temperature greater than 100° C., preferably between 120 and 180° C.

K. G. Strohmaier et al. (Exxon Mobil, WO2017202495A1) used the organic molecule 1,1′-(hexane-1,6-diyl)bis(1-methylpiperidinium) in the presence of a metal complex stabilized by amine ligands to obtain an AFX-structure zeolite with a crystallization time of 1 day to approximately 100 days and at temperatures between 100 and 200° C., preferably between 150 and 170° C.

The applicant has discovered that a high-purity AFX-structure zeolite can be prepared according to a particular method of synthesis, that is to say at crystallization temperatures of less than or equal to 95° C. Another advantage of this method of zeolite synthesis is that it is not necessary to use reactors which operate at a pressure greater than atmospheric pressure.

### SUMMARY OF THE INVENTION

The invention relates to a process for synthesizing a high-purity AFX zeolite, comprising at least the following steps:

i) mixing, in an aqueous medium, of at least one source of silicon (Si) in SiO₂ oxide form, at least one source of aluminum (Al) in Al₂O₃ oxide form, a nitrogenous organic compound R, R being 1,6-bis(methylpiperidinium)hexane dihydroxide, and at least one source of at least one alkali metal chosen from lithium, potassium or sodium, and the mixture of at least two of these metals, the reaction mixture having the following molar composition:

SiO₂/Al₂O₃ between 4 and 60, preferably between 8 and 40,

H₂O/SiO₂ between 5 and 60, preferably between 10 and 40,

R/SiO₂ between 0.05 and 0.50, preferably between 0.10 and 0.30,

M₂O/SiO₂ between 0.10 and 0.30, preferably between 0.15 and 0.25, until a homogeneous precursor gel is obtained;

ii) hydrothermal treatment of said precursor gel obtained at the end of step i) at a temperature of between 75° C. and 95° C., limits included, for a period of between 40 and 100 hours, limits included, to obtain a solid AFX-structure crystalline phase, termed “AFX zeolite”.

The SiO₂/Al₂O₃ ratio of the AFX zeolite obtained is advantageously between 4 and 60, limits included, preferably between 8 and 40, limits included.

Preferably, M is sodium.

The source of at least one alkali metal and/or alkaline-earth metal M is preferably sodium hydroxide.

It is possible to add seed crystals of an AFX-structure zeolite to the reaction mixture of step i), preferably in an amount of between 0.05% and 10% of the total mass of the sources of said Si and Al element(s) in anhydrous form used in the reaction mixture, said seed crystals not being taken into account in the total mass of the sources of the Si and Al elements.

Step i) may comprise a step of maturation of the reaction mixture at a temperature of between 20 and 60° C., with or without stirring, for a period of between 30 minutes and 48 hours.

The hydrothermal treatment of step ii) can be carried out under atmospheric pressure, preferably at a temperature of between 85° C. and 95° C., limits included, for a period preferably of between 40 and 80 hours, very preferably between 48 and 80 hours, limits included.

The solid phase obtained at the end of step ii) may be filtered off, washed, and dried at a temperature of between 20 and 150° C., preferably between 60 and 100° C., for a period of between 5 and 24 hours, to obtain a dried zeolite.

Preferably, the dried zeolite is then calcined at a temperature of between 450 and 700° C. for a period of between 2 and 20 hours, the calcination possibly being preceded by a gradual temperature increase.

The invention also relates to an AFX-structure zeolite with an SiO₂/Al₂O₃ ratio of between 4 and 60, obtained by the preparation process according to any one of the variants described above.

The invention also relates to an AFX-structure zeolite having an SiO₂/Al₂O₃ ratio of between 4 and 60, limits included, obtained by the preparation process described above and calcined, and for which the mean dₕₖₗ values and relative intensities measured on an X-ray diffraction pattern are as follows:

TABLE 1

| 2 theta (°) | dₕₖₗ (Å) | Iᵣₑₗ |
|---|---|---|
| 7.47 | 11.83 | mw |
| 8.56 | 10.32 | w |
| 8.67 | 10.19 | mw |
| 11.59 | 7.63 | w |
| 12.96 | 6.82 | mw |
| 14.99 | 5.91 | vw |
| 15.60 | 5.67 | w |
| 17.42 | 5.09 | mw |
| 17.77 | 4.99 | mw |
| 19.86 | 4.47 | w |
| 20.32 | 4.37 | m |
| 21.74 | 4.08 | VS |
| 22.52 | 3.95 | w |
| 26.06 | 3.42 | m |
| 27.69 | 3.22 | mw |
| 27.76 | 3.21 | w |
| 27.86 | 3.20 | mw |
| 29.74 | 3.00 | vw |
| 30.22 | 2.95 | mw |
| 30.49 | 2.93 | mw |
| 31.48 | 2.84 | mw |
| 33.57 | 2.67 | w |
| 34.68 | 2.58 | w |

where VS = very strong; S = strong; m = moderate; mw = moderately weak; w = weak; vw = very weak, the relative intensity Iᵣₑₗ being given in relation to a relative intensity scale in which a value of 100 is assigned to the most intense line in the X-ray diffraction pattern: vw < 15; 15 ≤ w ≤ 30; 30 ≤ mw < 50; 50 ≤ m < 65; 65 ≤ S < 85; VS ≥ 85.

### LIST OF FIGURES

FIG. 1 represents the chemical formula of the nitrogenous organic compound chosen as structuring agent used in the synthesis process according to the invention.

FIG. 2 represents the X-ray diffraction pattern of the AFX zeolite obtained according to Example 2.

Other characteristics and advantages of the process for synthesizing the AFX zeolite according to the invention will become apparent on reading the following description of non-limiting exemplary embodiments with reference to the appended figures described below.

### DESCRIPTION OF THE EMBODIMENTS

The invention relates to a process for synthesizing an AFX-structure zeolite, comprising at least the following steps:

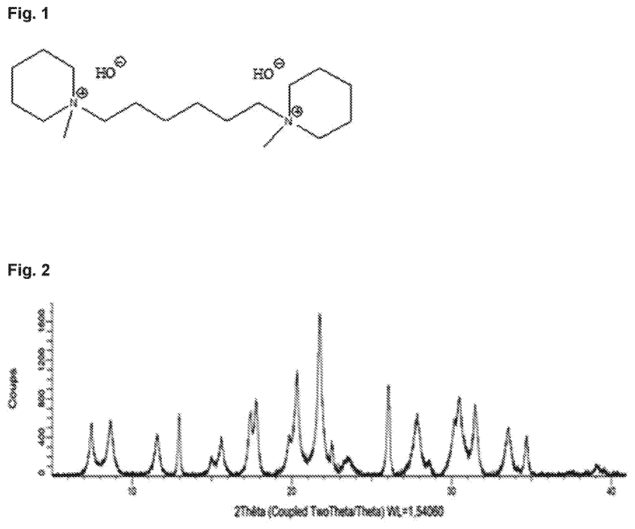

i) mixing, in an aqueous medium, of at least one source of silicon (Si) in SiO₂ oxide form, at least one source of aluminum (Al) in Al₂O₃ oxide form, a nitrogenous organic compound R, R being 1,6-bis(methylpiperidinium)hexane dihydroxide (FIG. 1), and at least one source of at least one alkali metal chosen from lithium, potassium or sodium, and the mixture of at least two of these metals, the reaction mixture having the following molar composition:

SiO₂/Al₂O₃ between 4 and 60, preferably between 8 and 40,

H₂O/SiO₂ between 5 and 60, preferably between 10 and 40,

R/SiO₂ between 0.05 and 0.50, preferably between 0.10 and 0.30,

M₂O/SiO₂ between 0.10 and 0.30, preferably between 0.15 and 0.25, until a homogeneous precursor gel is obtained;

ii) hydrothermal treatment of said precursor gel obtained at the end of step i) at a temperature of between 75 and 95° C., limits included, preferably between 85° C. and 95° C., for a period of between 40 and 100 hours.

The SiO₂/Al₂O₃ ratio of the AFX zeolite obtained is advantageously between 4 and 60, preferably between 8 and 40, limits included.

Preferably, M is sodium.

Preferably, the source of at least one alkali metal is sodium hydroxide.

Seed crystals of an AFX-structure zeolite can be added to the reaction mixture of step i), preferably in an amount of between 0.05% and 10% of the total mass of SiO₂ and Al₂O₃, said seed crystals not being taken into account in the total mass of the sources of the elements Si and Al.

Step i) may comprise a step of maturation of the reaction mixture at a temperature of between 20 and 60° C., with or without stirring, for a period of between 30 minutes and 48 hours.

The hydrothermal treatment of step ii) is advantageously carried out under reflux at a temperature of between 75 and 95° C., preferably between 85° C. and 95° C., limits included, for a period of between 40 and 100 hours, preferably between 48 and 80 hours. Preferably, the pressure is atmospheric pressure.

More particularly, the process according to the present invention comprises a step i) of mixing, in an aqueous medium, of at least one source of silicon (Si) in SiO₂ oxide form, at least one source of aluminum (Al) in Al₂O₃ oxide form, a nitrogenous organic compound R, R being 1,6-bis(methylpiperidinium)hexane dihydroxide, and at least one source of at least one alkali metal chosen from lithium, potassium or sodium, and the mixture of at least two of these metals, the reaction mixture having the following molar composition:

SiO₂/Al₂O₃ between 4 and 60, preferably between 8 and 40,

H₂O/SiO₂ between 5 and 60, preferably between 10 and 40,

R/SiO₂ between 0.05 and 0.50, preferably between 0.10 and 0.30,

M₂O/SiO₂ between 0.10 and 0.30, preferably between 0.15 and 0.25, until a homogeneous precursor gel is obtained;

then a step ii) of hydrothermal treatment of said precursor gel obtained at the end of step i) at a temperature of between 75° C. and 95° C., preferably between 85° C. and 95° C., limits included, for a period of between 40 and 100 hours, preferably between 48 and 80 hours, until said high-purity AFX-structure zeolite forms.

In the molar composition of the reaction mixture above and throughout the description:

SiO₂ denotes the molar amount of silicon expressed in oxide form, and Al₂O₃ denotes the molar amount of aluminum expressed in oxide form,

H₂O the molar amount of water present in the reaction mixture,

R the molar amount of said nitrogenous organic compound,

M₂O the molar amount expressed in oxide form of M₂O by the source of alkali metal.

One advantage of the present invention is therefore that it provides a novel preparation process for forming a pure AFX-structure zeolite at the end of step ii).

Another advantage of the present invention is that it allows the preparation of a precursor gel of an AFX-structure zeolite by virtue of the combination of an organic or specific structuring species comprising two quaternary ammonium functions, 1,6-bis(methylpiperidinium)hexane dihydroxide, and of very specific operating conditions, notably a controlled temperature.

Step ii) comprises a hydrothermal treatment of said precursor gel obtained at the end of step i) which is carried out at a temperature of between 75° C. and 95° C., preferably between 85° C. and 95° C., limits included, for a period of between 40 and 100 hours, preferably between 48 and 80 hours, until said AFX-structure zeolite crystallizes. It is thus possible to carry out this step at atmospheric pressure, notably in a reactor open to the atmosphere.

In accordance with the invention, at least one source of at least one oxide SiO₂ is incorporated into the mixture for carrying out step (i) of the preparation process. The source of silicon may be any one of said sources commonly used for zeolite synthesis, for example powdered silica, silicic acid, colloidal silica, dissolved silica or tetraethoxysilane (TEOS). Among the powdered silicas, use may be made of precipitated silicas, notably those obtained by precipitation from a solution of alkali metal silicate, fumed silicas, for example Aerosil, and silica gels. Colloidal silicas having various particle sizes, for example a mean equivalent diameter of between 10 and 15 nm or between 40 and 50 nm, may be used, such as those sold under registered trademarks such as Ludox. Preferably, the source of silicon is Ludox HS-40.

In accordance with the invention, at least one source of Al₂O₃ is incorporated into the mixture for carrying out said step (i). The source of aluminum is preferably aluminum hydroxide or an aluminum salt, for example chloride, nitrate or sulfate, a sodium aluminate, an aluminum alkoxide, or alumina itself, preferably in hydrated or hydratable form, for instance colloidal alumina, pseudoboehmite, gamma-alumina or alpha or beta alumina trihydrate. Use may also be made of mixtures of the sources mentioned above.

In accordance with the invention, R is a nitrogenous organic compound, 1,6-bis(methylpiperidinium)hexane dihydroxide, said compound being incorporated into the reaction mixture for the implementation of step (i), as organic structuring agent. The anion associated with the quaternary ammonium cations present in the organic structuring species for the synthesis of an AFX-structure zeolite according to the invention is the hydroxide anion.

In accordance with the invention, at least one source of at least one alkali metal is used in the reaction mixture of step i), M preferably being chosen from lithium, potassium, sodium and the mixture of at least two of these metals. Very preferably, M is sodium.

The source of at least one alkali metal and/or alkaline-earth metal M is preferably sodium hydroxide.

It may be advantageous to add seeds of an AFX-structure zeolite to the reaction mixture during said step i) of the process of the invention so as to reduce the time needed for the formation of the crystals of an AFX-structure zeolite and/or the total crystallization time. Said seed crystals also promote the formation of said AFX-structure zeolite to the detriment of impurities. Such seeds comprise crystalline solids, notably crystals of an AFX-structure zeolite. The seed crystals are generally added in a proportion of between 0.05% and 10% of the total mass of the sources of said element(s) Si and Al in anhydrous form used in the reaction mixture, said seed crystals not being taken into account in the total mass of the sources of the elements Si and Al. Said seeds are not taken into account either for determining the composition of the reaction mixture and/or of the gel, defined above, i.e. in the determination of the various molar ratios of the composition of the reaction mixture.

The mixing step i) is performed until a homogeneous mixture is obtained, preferably for a period of greater than or equal to 10 minutes, preferably with stirring by any system known to those skilled in the art, at a low or high shear rate.

At the end of step i), a homogeneous precursor gel is obtained.

It may be advantageous to perform a maturation of the reaction mixture during said step i) of the process of the invention, before the hydrothermal crystallization, so as to control the size of the crystals of an AFX-structure zeolite. Said maturation also promotes the formation of said AFX-structure zeolite to the detriment of impurities. Maturation of the reaction mixture during said step i) of the process of the invention may be performed at ambient temperature or at a temperature of between 20 and 60° C. with or without stirring, for a period advantageously of between 30 minutes and 48 hours.

In accordance with step ii) of the process according to the invention, the precursor gel obtained at the end of step i) is subjected to a hydrothermal treatment, carried out at a temperature of between 75 and 95° C., preferentially carried out at a temperature of between 85 and 95° C., limits included, for a period of between 40 and 100 hours, until said AFX-structure zeolite is formed.

The time required to obtain crystallization ranges between 40 and 100 hours, preferably between 48 and 80 hours.

The reaction is generally carried out with or without stirring, preferably with stirring. The stirring system that may be used is any system known to those skilled in the art, for example inclined paddles with counter-blades, stirring turbomixers or endless screws.

At the end of the reaction, after performing said step ii) of the preparation process according to the invention, the solid phase formed from an AFX-structure zeolite is preferably filtered off, washed and then dried. The drying is generally performed at a temperature of between 20° C. and 150° C., preferably between 60° C. and 100° C., for a period of between 5 and 24 hours.

It is also advantageous to obtain the protonated form of the AFX-structure zeolite obtained via the process according to the invention. Said protonated form may be obtained by performing an ion exchange with an acid, in particular a strong mineral acid such as hydrochloric, sulfuric or nitric acid, or with a compound such as ammonium chloride, sulfate or nitrate. The ion exchange may be performed by placing said AFX-structure zeolite in suspension one or more times with the ion-exchange solution. Said zeolite may be calcined before or after the ion exchange or between two ion-exchange steps. The zeolite is preferably calcined before the ion exchange, so as to remove any organic substance included in the porosity of the zeolite, since the ion exchange is thereby facilitated.

At the end of said step ii) of preparation of the AFX zeolite, X-ray diffraction makes it possible to confirm that the solid obtained by the process according to the invention is indeed an AFX-structure zeolite. The purity obtained is advantageously greater than 90%, preferably greater than 95% and very preferably greater than 99.8% by weight.

This diffraction pattern is obtained by radiocrystallographic analysis by means of a diffractometer using the conventional powder method with the Kai radiation of copper (A=1.5406 Å). On the basis of the position of the diffraction peaks represented by the angle 2θ, the lattice constant distances dₕₖₗ characteristic of the sample are calculated using the Bragg relationship. The measurement error Δ(dₕₖₗ) over dₕₖₗ is calculated by means of Bragg's law as a function of the absolute error Δ(2θ) assigned to the measurement of 2θ. An absolute error Δ(2θ) equal to ±0.02° is commonly accepted. The relative intensity I_{ref} assigned to each value of dₕₖₗ is measured according to the height of the corresponding diffraction peak. The X-ray diffraction pattern of the AFX-structure crystalline solid according to the invention includes at least the lines at the dₕₖₗ values given in table 1. In the column of the dₕₖₗ values, the mean values of the lattice spacings have been shown in angströms (Å). Each of these values must be assigned the measurement error Δ(dₕₖₗ) of between ±0.6 Å and ±0.01 Å.

Table 1: Mean dₕₖₗ values and relative intensities measured on an X-ray diffraction pattern of the AFX-structure crystalline solid.

TABLE 1

| 2 theta (°) | dₕₖₗ (Å) | Iᵣₑₗ |
|---|---|---|
| 7.47 | 11.83 | mw |
| 8.56 | 10.32 | w |
| 8.67 | 10.19 | mw |
| 11.59 | 7.63 | w |
| 12.96 | 6.82 | mw |
| 14.99 | 5.91 | vw |
| 15.60 | 5.67 | w |
| 17.42 | 5.09 | mw |
| 17.77 | 4.99 | mw |
| 19.86 | 4.47 | w |
| 20.32 | 4.37 | m |
| 21.74 | 4.08 | VS |
| 22.52 | 3.95 | w |
| 26.06 | 3.42 | m |
| 27.69 | 3.22 | mw |
| 27.76 | 3.21 | w |
| 27.86 | 3.20 | mw |
| 29.74 | 3.00 | vw |
| 30.22 | 2.95 | mw |
| 30.49 | 2.93 | mw |
| 31.48 | 2.84 | mw |
| 33.57 | 2.67 | w |
| 34.68 | 2.58 | w |

X-ray fluorescence spectrometry (XFS) is a chemical analysis technique using a physical property of matter, X-ray fluorescence. It enables the analysis of the majority of the chemical elements starting from beryllium (Be) in concentration ranges ranging from a few ppm to 100%, with precise and reproducible results. X-rays are used to excite the atoms in the sample, which makes them emit X-rays having an energy characteristic of each element present. The intensity and the energy of these X-rays are then measured to determine the concentration of the elements in the material.

### Advantages of the Invention

The AFX-structure zeolite obtained exhibits improved purity and improved ease of preparation compared to the prior art catalysts.

One advantage of the present invention is therefore that it provides a novel preparation process for the low-temperature formation of an AFX-structure zeolite free of other crystalline phases.

Another advantage of the present invention is that it allows the preparation of a precursor gel of an AFX-structure zeolite by virtue of the combination of an organic or specific structuring species comprising two quaternary ammonium functions, 1,6-bis(methylpiperidinium)hexane dihydroxide, and of very specific operating conditions, notably a crystallization temperature of between 75° C. and 95° C., limits included.

The high-purity AFX-structure zeolite obtained by the synthesis process according to the invention may be used, after ion exchange, as acidic solid for catalysis in the refining and petrochemistry fields. It may also be used as an adsorbent or as a molecular sieve.

### EXAMPLES

The invention is illustrated by the examples that follow, which are not in any way limiting in nature.

### Example 1: Preparation of 1,6-Bis(Methylpiperidinium)Hexane Dihydroxide (Structuring Agent R)

50 g of 1,6-dibromohexane (0.20 mol, 99%, Alfa Aesar) are placed in a 1 L round-bottom flask containing 50 g of N-methylpiperidine (0.51 mol, 99%, Alfa Aesar) and 200 mL of ethanol. The reaction medium is stirred and refluxed for 5 hours. The mixture is then cooled to ambient temperature and then filtered. The mixture is poured into 300 mL of cold diethyl ether and the precipitate formed is then filtered off and washed with 100 mL of diethyl ether. The solid obtained is recrystallized in an ethanol/ether mixture.

The solid obtained is dried under vacuum for 12 hours. 71 g of a white solid are obtained (i.e. a yield of 80%).

The product has the expected ¹H NMR spectrum. ¹H NMR (D₂O, ppm/TMS): 1.27 (4H, m); 1.48 (4H, m); 1.61 (4H, m); 1.70 (8H, m); 2.85 (6H, 5), 3.16 (12H, m).

18.9 g of Ag₂O (0.08 mol, 99%, Aldrich) are placed in a 250 ml Teflon beaker containing 30 g of the structuring agent 1,6-bis(methylpiperidinium)hexane dibromide (0.07 mol) prepared and 100 mL of deionized water. The reaction medium is stirred for 12 hours in the absence of light. The mixture is then filtered. The filtrate obtained is composed of an aqueous solution of 1,6-bis(methylpiperidinium)hexane dihydroxide. Assaying of this species is performed by proton NMR using formic acid as standard.

### Example 2: Preparation of a Catalyst Containing an AFX-Structure Zeolite According to the Invention

Preparation of the AFX Zeolite

49.83 g of an aqueous solution of 1,6-bis(methylpiperidinium)hexane dihydroxide (18.36% by weight) prepared according to example 1 were mixed with 0.466 g of deionized water. 2.1 g of sodium hydroxide (solid, 98% by weight purity, Aldrich) are added to the above mixture, and the preparation obtained is kept stirring for 10 minutes. Subsequently, 1.66 g of sodium aluminate (53.17% Al₂O₃ by weight, Strem Chemicals) are incorporated and the synthesis gel is kept stirring for 15 minutes. Lastly, 25.96 g of colloidal silica (Ludox HS40, 40% SiO₂ by weight, Aldrich) and 1.038 g of seeds of an AFX-structure zeolite obtained by any method known by those skilled in the art were incorporated into the synthesis mixture. The molar composition of the mixture, without taking into account the seeds, is as follows: 100 SiO₂: 5 Al₂O₃: 16.7 R: 22.36 Na₂O: 1836 H₂O, i.e. an SiO₂/Al₂O₃ ratio of 10. The precursor gel is then transferred, after homogenization, into a reactor equipped with a reflux condenser. The reactor is then heated with an increase in temperature of 5° C./min up to 95° C. for 40 hours with stirring at 200 rpm using a system with 4 inclined paddles. The crystallized product obtained is filtered off, washed with deionized water and then dried overnight at 100° C. The loss on ignition of the product obtained after drying is 15%. The solid is then introduced into a muffle furnace where a calcination step is performed: the calcination cycle comprises an increase in temperature of 1.5° C./min up to 200° C., a steady stage at 200° C. maintained for 2 hours, an increase in temperature of 1° C./min up to 550° C., followed by a steady stage at 550° C. maintained for 8 hours, then a return to ambient temperature.

The calcined solid product was analyzed by X-ray diffraction and identified as consisting of an AFX-structure zeolite with a purity of greater than 99.8%. The diffraction pattern produced for the calcined AFX-structure solid is given in FIG. 2. The product has an SiO₂/Al₂O₃ molar ratio of 12 as determined by X-ray fluorescence.

1. A process for synthesizing a high-purity AFX zeolite, comprising at least the following steps:
i) mixing, in an aqueous medium, of at least one source of silicon (Si) in SiO₂ oxide form, at least one source of aluminum (Al) in Al₂O₃ oxide form, a nitrogenous organic compound R, R being L6-bis(methylpiperidinium)hexane dihydroxide, and at least one source of at least one alkali metal M chosen from lithium, potassium or sodium, and the mixture of at least two of these metals, the reaction mixture having the following molar composition:
SiO₂/Al₂O₃ between 4 and 60, preferably between 8 and 40,
H₂O/SiO₂ between 5 and 60, preferably between 10 and 40,
R/SiO₂ between 0.05 and 0.50, preferably between 0.10 and 0.30,
M₂O/SiO₂ between 0.10 and 0.30, preferably between 0.15 and 0.25,
until a homogeneous precursor gel is obtained;
ii) hydrothermal treatment of the precursor gel obtained at the end of step i) at a temperature of between 75° C. and 95° C., limits included, for a period of between 40 and 100 hours, limits included, to obtain a solid AFX-structure crystalline phase, termed “AFX zeolite”.

2. The process as claimed in claim 1, wherein M is sodium.

3. The process as claimed in claim 2, wherein the source of at least one alkali metal M is sodium hydroxide.

4. The process as claimed in claim 1, wherein seed crystals of an AFX-structure zeolite are added to the reaction mixture of step i), preferably in an amount of between 0.05% and 10% of the total mass of the sources of said Si and Al element(s) in anhydrous form used in the reaction mixture, the seed crystals not being taken into account in the total mass of the sources of the Si and Al elements.

5. The process as claimed in or claim 1, wherein step i) comprises a step of maturing the reaction mixture at a temperature of between 20 and 60° C., with or without stirring, for a period of between 30 minutes and 48 hours.

6. The process as claimed in claim 1, wherein the hydrothermal treatment of step ii) is carried out under atmospheric pressure.

7. The process as claimed in claim 1, wherein the hydrothermal treatment of step ii) is carried out at a temperature of between 85° C. and 95° C., limits included, for a period of between 40 and 80 hours, preferably between 48 and 80 hours, limits included.

8. The process as claimed in claim 1, wherein, after the step ii) has been carried out, the solid phase formed of an AFX-structure zeolite obtained at the end of step ii) is filtered, washed, and dried at a temperature of between 20 and 150° C., preferably between 60 and 100° C., for a period of between 5 and 24 hours to obtain a dried zeolite.

9. The process as claimed in claim 8, wherein the dried zeolite is then calcined at a temperature of between 450 and 700° C. for a period of between 2 and 20 hours, the calcination possibly being preceded by a gradual temperature increase.

10. An AFX-structure zeolite having an SiO₂/Al₂O₃ ratio of between 4 and 60, obtained by the preparation process as claimed in claim 1.

11. An AFX-structure zeolite having an SiO₂/Al₂O₃ ratio of between 4 and 60, limits included, obtained by the preparation process as claimed in claim 9 for which the mean did values and relative intensities measured on an X-ray diffraction pattern are as follows, where VS=very strong; S=strong; m=moderate; mw=moderately weak; w=weak; vw=very weak, the relative intensity I_{ref} being given in relation to a relative intensity scale in which a value of 100 is assigned to the most intense line in the X-ray diffraction pattern: vw<15; 15≤w≤30; 30≤mw<50; 50≤m<65; 65≤S≤85; VS≥85:
TABLE 1

| 2 theta (°) | dₕₖₗ (Å) | Iᵣₑₗ |
|---|---|---|
| 7.47 | 11.83 | mw |
| 8.56 | 10.32 | w |
| 8.67 | 10.19 | mw |
| 11.59 | 7.63 | w |
| 12.96 | 6.82 | mw |
| 14.99 | 5.91 | vw |
| 15.60 | 5.67 | w |
| 17.42 | 5.09 | mw |
| 17.77 | 4.99 | mw |
| 19.86 | 4.47 | w |
| 20.32 | 4.37 | m |
| 21.74 | 4.08 | VS |
| 22.52 | 3.95 | w |
| 26.06 | 3.42 | m |
| 27.69 | 3.22 | mw |
| 27.76 | 3.21 | w |
| 27.86 | 3.20 | mw |
| 29.74 | 3.00 | vw |
| 30.22 | 2.95 | mw |
| 30.49 | 2.93 | mw |
| 31.48 | 2.84 | mw |
| 33.57 | 2.67 | w |
| 34.68 | 2.58 | w |
